(19) United States
(12) Patent Application Publication
(10) Pub. No.: US 2018/0127015 A1
(43) Pub. Date: May 10, 2018

(54) SPRING CLAMP AND UV PROTECTOR

(71) Applicant: Steiner Innovations, Newport Beach, CA (US)

(72) Inventors: Richard Francis Steiner, Arroyo Grande, CA (US); Donald William Steiner, Newport Beach, CA (US)

(21) Appl. No.: 15/723,090

(22) Filed: Oct. 2, 2017

Related U.S. Application Data
(63) Continuation-in-part of application No. 15/623,695, filed on Jun. 15, 2017.
(60) Provisional application No. 62/418,059, filed on Nov. 4, 2016.
(60) Provisional application No. 62/418,051, filed on Nov. 4, 2016.

(51) Int. Cl. B62B 9/14; E06B 9/42; B25B 5/06

(52) U.S. Cl. CPC B62B 9/145; B25B 5/06; E06B 9/42

(57) ABSTRACT

The system provides a roller shade apparatus that can be affixed to any of a plurality of infant and toddler carriers (including strollers, playpens, car seats, rockers, and the like). A pair of adjustable clips allow for the roller shade to be mounted on carriers of a variety of configurations. Once in place the shade can be unrolled to the desired length and the length can be fixed via a novel attachment clamp that can be used in conjunction with a stroller screen. A slot portion of the clamp slides over and is attached to an adjustable strap at the bottom of the shade at a location on the strap that allows the clamp to attach to a stroller frame, canopy or other part of the stroller structure.

This patent application claims priority to U.S. Provisional Patent Application No. 62/418,051 filed on Nov. 4, 2016, U.S. Provisional Patent Application No. 62/418,059 filed Nov. 4, 2016 and U.S. patent application Ser. No. 15/623,695 filed on Jun. 15, 2017, all of which are incorporated by reference herein in their entirety.

### BACKGROUND OF THE SYSTEM

There has been inadequate UV eye and skin protection for children (e.g. infants and toddlers) who are too young to wear sun glasses, in carriers. Also, methods to protect the child's eyes and skin (i.e. blankets) have resulted in dangerous thermal conditions. Large UV film panels that cover a large part of the carrier have been marketed that are difficult to attach and store.

Current methods such as blankets to cover the child's eyes and skin provide poor ventilation and result in dangerous thermal conditions. Other apparatuses are difficult to attach, remove, and store, and require larger shipping and storage packages.

### SUMMARY

The system provides a roller shade apparatus that can be affixed to any of a plurality of infant and toddler carriers (including strollers, playpens, car seats, rockers, and the like). A pair of adjustable clips allow for the roller shade to be mounted on carriers of a variety of configurations. Once in place the shade can be unrolled to the desired length and the length can be fixed via a novel attachment clamp that can be used in conjunction with a stroller screen. A slot portion of the clamp slides over and is attached to an adjustable strap at the bottom of the shade at a location on the strap that allows the clamp to attach to a stroller frame, canopy or other part of the stroller structure. The clamp can also be movably placed in different positions on the strap itself, increasing the variations and sizes of applications of the clamp and associated stroller screen.

### BRIEF DESCRIPTION OF THE DRAWINGS

FIG. 1 is the assembly drawing for the clamp.

FIG. 2 is an embodiment of the shade assembly of the system.

FIG. 3 is a reverse view of the shade assembly of FIG. 2.

FIG. 4 is an exploded view of the shade assembly of the system.

### DETAILED DESCRIPTION OF THE SYSTEM

There is a UV screen for child carriers described in U.S. patent Ser. No. 15/623,695 filed on Jun. 15, 2017, which is incorporated by reference herein in its entirety. The UV screen is adaptable to be used with a variety of strollers and carriers and can be attached at multiple desirable locations on such strollers and carriers.

The present system includes a spring roller mechanism that can be attached to a variety of carriers via two adjustable clips. The spring roller mechanism includes a shade that can be pulled out from the roller to a desired length and held in place by a clip coupled to a strap, string, wire embedded fabric, and the like. The clamp of the present system provides flexibility in attaching objects such as the UV shade described above. In addition, other objects can utilize the clamp to provide adaptable fastening of objects.

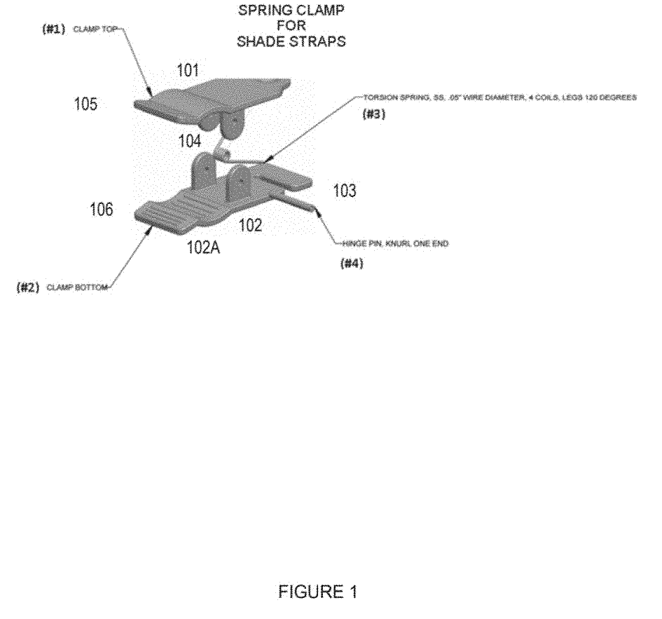

Referring to FIG. 1, the clamp in one embodiment is illustrated. In this embodiment, the claim is comprised of a top portion 101 and bottom portion 102. The top portion 101 is placed over the bottom portion 102 such that the pin holes on each clamp tab are lined up. A torsion spring 104 is placed between the clamp portions such that the torsion spring is aligned between the tab pin holes. A hinge pin (#4) is inserted through the clamp portions/spring combination to provide a completed spring clamp.

The spring clamp of this embodiment includes a slot 103 into which an adjustable strap may be inserted at a plurality of positions. In one embodiment, the slot extends nearly across the bottom portion 102 of the clamp. The width of the slot 103 is such that a strap will be slightly compressed in the slot, causing it to be held in position during use. The clamp/slot design allows the clamp to be placed at a plurality of positions on a strap so that different fastening configurations of the UV screen may be performed accordingly.

The clamp includes end 105 on the top portion and end 106 on the bottom portion. The ends include a flat portion and a curved portion. The flat portions can be used for attaching the clamp to fabric or other locations where a pressure fit is required. The curved portion allows the clamp to be utilized on a bar or tube with the curved portion extending partially around the top and bottom of the bar or tube to provide additional hold to the clamp when in use. On the back of bottom portion 102 is region 102A that may include a Velcro pad for attaching the clamp to other locations.

In another embodiment, the slot may be located within the boundaries of the bottom portion so that a strap is inserted through the slot to a desired fastening position. The use of the clamp provides a way for the UV protection device to be affixed to a plurality of objects.

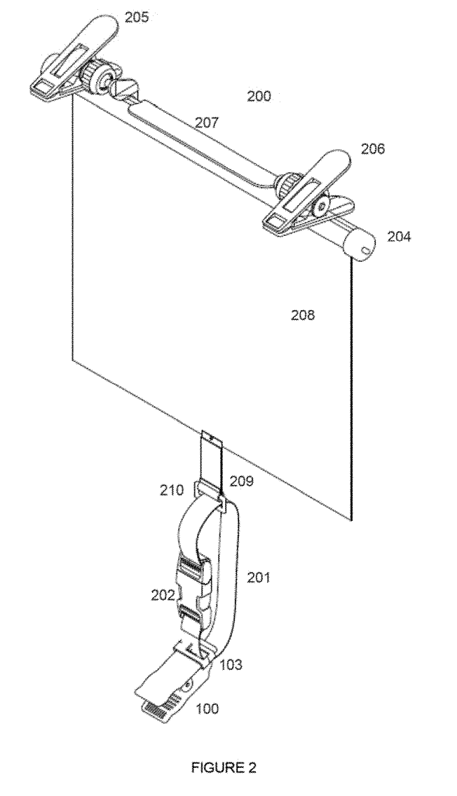

FIG. 2 illustrates an embodiment of the clamp in use with a UV screen assembly 200. The clamp 100 is attached to a strap 201 that is used to pull a roller shade portion of the UV shade to a desired length. The strap 201 includes a fastener/clip 202 that is used to control the length of the strap as desired. The clamp 100 is affixed to the strap 201 by inserting strap 201 into slot 103 of clamp 100. The clamp 100 can be placed at any location on the strap as desired in order to provide a means for securing the roller shade at a desired length and at a desired location.

In one embodiment, the spring may be replaced with a “C” shaped member that provides spring force and urges the top and bottom portions to a closed position. A user can overcome this urgent force to open the clip and releases the urgent force to maintain the clamp at a closed position as desired.

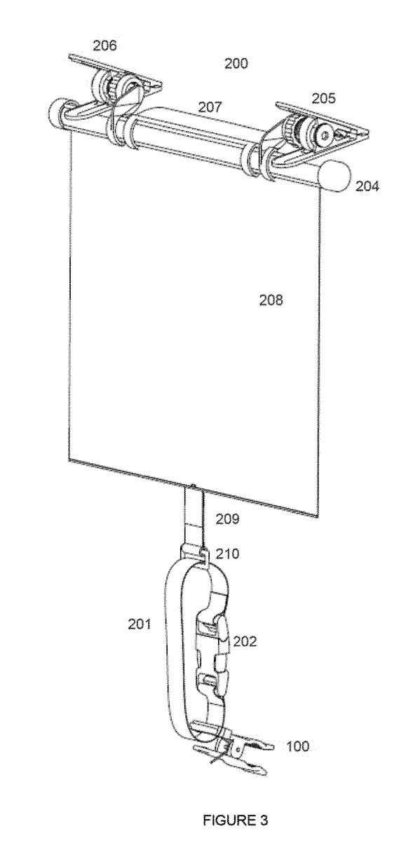

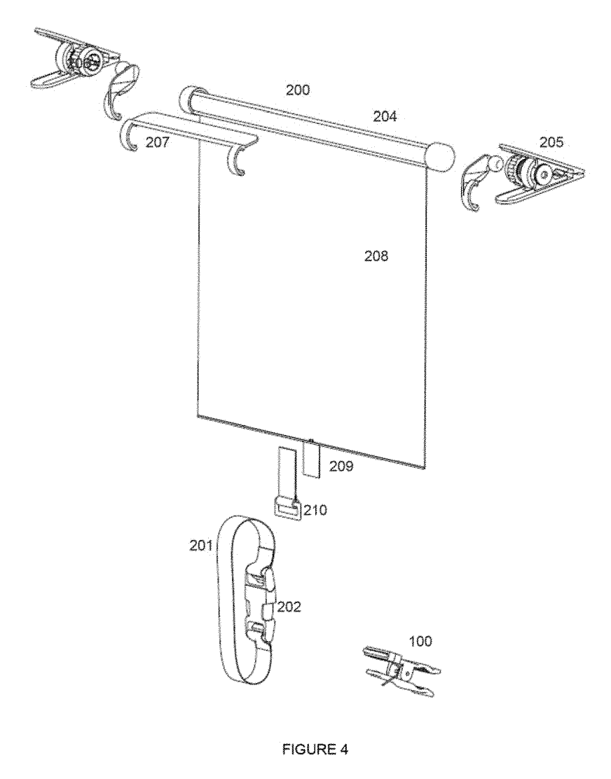

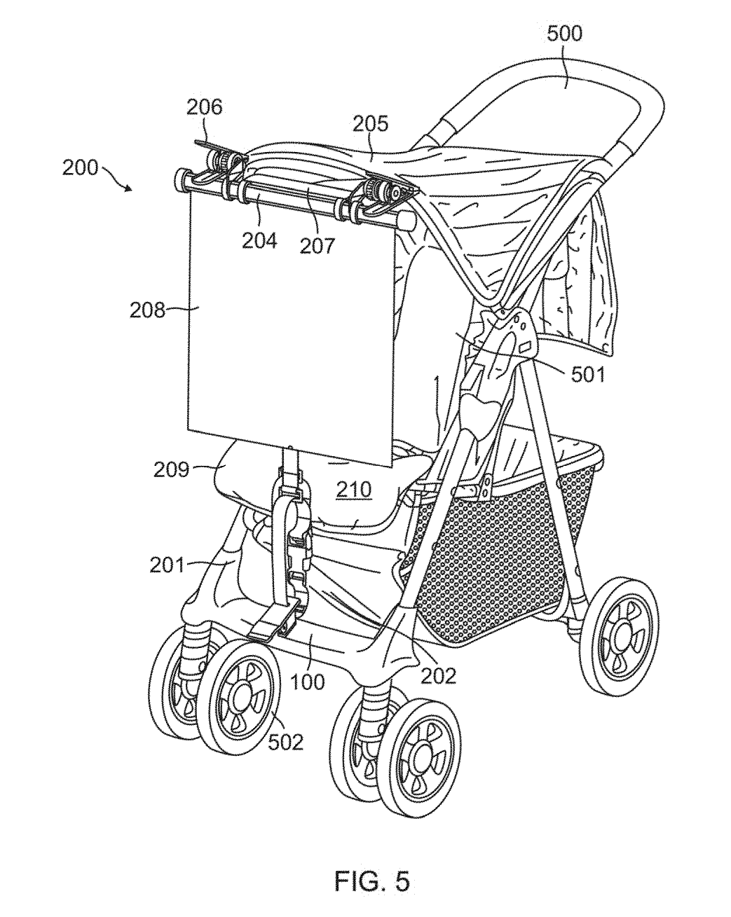

FIGS. 2-4 illustrate an embodiment of a UV shade assembly that may be used with or without the clamp 100 of FIG. 1. The assembly includes the roller mechanism 204 that retains the shade 208 when not in use and allows the shade 208 to be unrolled to a desired length during operation. The roller mechanism 204 includes first and second clips 205, 206 that can rotate on the roller mechanism 204 to allow the assembly 200 to be securely fastened to a carrier in a plurality of orientations. A vertical member sunshield 207 may also be attached to the roller assembly and positioned to fill in gaps in shade protection between the roller assembly 200 and a carrier.

The shade portion 208 of the assembly 200 is mounted on a spring actuated roller mechanism in the manner of a window blind, with ratchet mechanisms that can allow the shade to pulled out to a variety of lengths without springing back into the roller mechanism 204. The shade can be comprised of a mesh, polyethylene, PVC, or other material that provides UV protection, such as a sun shade screen. The screen can have a UV protection of 30-95% depending on the mateial. For example, using a PVC material can provide 83% UV protection. A UV shade allows airflow to the child while still providing desired UV protection. The shade may also be comprised of a tinted plastic fil that is flexible and provides UV protection.

In one embodiment, the roller mechanism 204 is configured so that the shade can be extended in half inch increments and held in place, similar to a roller blind. The shade may be retracted by activation of button which causes the spring biased shade 208 to retract into the mechanism 204. In one embodiment, the shade can extend 24 inches. However, other lengths can be accommodated in the present system. The width of the shade may be 14 inches in one embodiment and the width of the roller mechanism 204 may be 17-18 inches. However, these dimensions are for purposes of example and the apparatus may be of other dimensions.

The bottom of the shade 208 includes an attached strap 209 with a ring 210 for attaching strap 201. The strap 209 remains outside of the roller mechanism 204 so that the shade 208 can be easily withdrawn from the mechanism 204 by pulling on the strap 209. Strap 201 can be inserted through the ring 210 and fastened into a loop via clip 202 so that a variety of lengths of the shade can be achieved. The clamp 100 can be affixed to the strap 201 at a plurality of locations so that the claim 100 can be attached to the frame of a carrier at a desired location to provide desired protection to the child.

There are no current devices that provide a quick attach and release connection from a wire embedded fabric strap to a stroller.

FIG. 5 illustrates an embodiment of the apparatus 200 attached to a stroller 500. The stroller includes a canopy with a frame 501 that defines the shape of the canopy and acts somewhat as a shade device on the stroller. However, the canopy does not provide adequate UV eye and skin protection of a child in the stroller. The apparatus 200 may be attached to the frame 501 using clips 205 and 206 which can open and grab the frame 501. The shade 208 can be pulled from the roller 204 and attached to a bottom frame member 502 using clip 100. This allows the shade apparatus to stay in place and provide additional eye and skin protection for a child in the stroller 500.

The spring clamp provides a means to quickly attach and disconnect a sun screen with wire embedded fabric straps (used on infant strollers) to a variety of toddler strollers.

What is claimed is:

1. A spring clamp comprising:
a top portion and a bottom portion pivotally coupled together with a spring member that urges a first end of the top portion to engage a first end of the bottom portion;
a slot formed in the bottom portion so that the clamp can be selectively located on a strap or other member of an object to be secured.

2. The device of claim 1 wherein the spring clamp is attached to a fabric strap of a sun screen by sliding the slot of the spring clamp over the strap at a selected point on the strap.

3. The device of claim 2 wherein the clamp is then attached to an optimum place on a stroller or carrier such as the canopy or structure.
